(19) United States
(12) Patent Application Publication
(10) Pub. No.: US 2005/0035132 A1
(43) Pub. Date: Feb. 17, 2005

(54) Spinning eye and mouth character candy dispenser

(76) Inventors: Gary Weiss, Manhattan Beach, CA (US); Daniel G. Hart, Manhattan Beach, CA (US)

Correspondence Address: CISLO & THOMAS, LLP, 233 WILSHIRE BLVD, SUITE 900, SANTA MONICA, CA, 90401-1211, US

(21) Appl. No.: 10/632,594

(22) Filed: Aug. 1, 2003

(51) Int. Cl. G07F 11/00; A24F 15/04

(52) U.S. Cl. 221/24

(57) ABSTRACT

Provided is a dispensing system, including a container configured with one or more apertures, and configured to house items, a faceplate configured with one or more dispensing apertures, rotationally coupled to the container, such that the items may be dispensed from the container, and one or more novelties coupled to the container, configured to move when the faceplate rotates with respect to the container.

### BACKGROUND

There may be a demand for dispensers which serve as containers for small confections, and the like, that include features that may attract a purchaser. Such dispensers enable purchasers, such as children, to carry confections, including candy, chewing gum, and the like, under relatively sanitary conditions and to dispense such confections as desired without the danger of spilling and/or contaminating the entire quantity of confections.

Confection dispensers are generally well known in the art and come in a wide variety of shapes and sizes. A relatively high percentage of candy purchases may be made by, or at the insistence of, children. However, the typical child may have little, if any, brand loyalty, and thus candy manufacturers may have long relied on clever packaging in order to attract the purchaser's attention. One marketing approach may be to put the candy in an attractive candy dispenser designed to appeal to children and/or adults. For example, many members of the public can recall the very popular Pez® candy dispensers. Other candy packages may rely on the use of licensed cartoon characters, action figures, or even the name of a popular sports personality. Thus, it may be a commonly held belief that a candy container or dispenser that incorporates one or more novel or unique features is very likely to significantly increase the sales of that candy product. Therefore, there is a continuing need for novel candy containers and dispensers.

### SUMMARY

Provided is a dispensing system, including a container configured with one or more apertures, and configured to house items, a faceplate configured with one or more dispensing apertures, rotationally coupled to the container, such that the items may be dispensed from the container, and one or more novelties coupled to the container, configured to move when the faceplate rotates with respect to the container.

### BRIEF DESCRIPTION OF THE DRAWINGS

FIG. 1 is a perspective view of an exemplary embodiment according to the present invention.

FIG. 2 is an exploded view of the exemplary embodiment of FIG. 1.

FIG. 3 is a further exploded view of the exemplary embodiment of FIG. 1.

FIGS. 4a-c are top views of an exemplary embodiments showing various novelties.

### DETAILED DESCRIPTION

The detailed description set forth below in connection with the appended drawings is intended as a description of exemplary embodiments and is not intended to represent the only forms in which the embodiments may be constructed and/or utilized. The description also sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

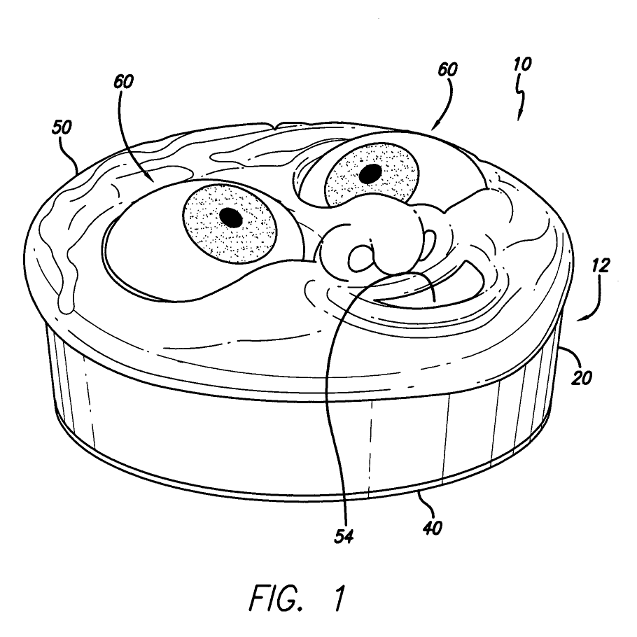

A perspective view of an item dispensing system according to one embodiment of the present invention is shown in FIG. 1, generally at 10. System 10 typically includes a container 12 coupled to a faceplate 50 and including novelty portions 60 that may be configured to rotationally couple to container 12 or to faceplate 50. Container 12 is made up of a top housing 20 and a bottom housing 40 that are configured to couple to each other to form an enclosure therein. When faceplate 50 is rotated with respect to container 12, novelty portions 60 may be configured to rotate also. Faceplate 50 typically includes a dispensing aperture 54 that is configured to allow items to pass there through. System 10 is typically configured to hold confectionaries, such as candy or other items, and to selectively dispense those items, as desired.

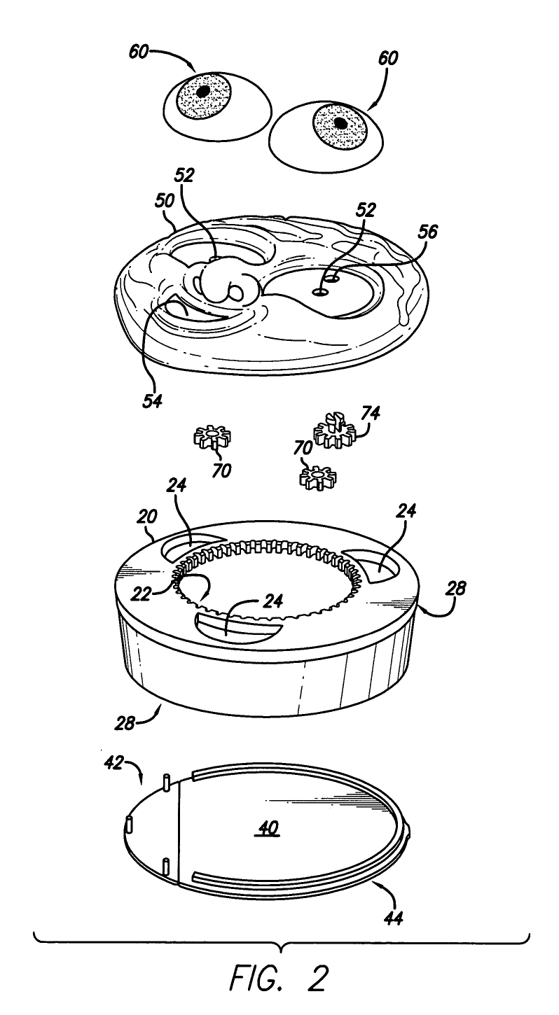

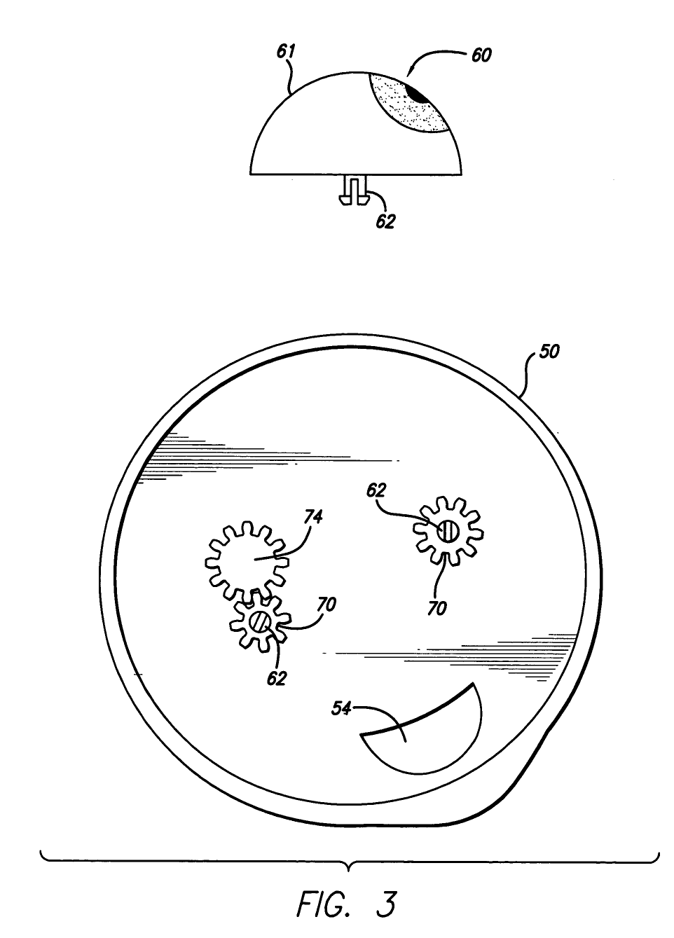

FIGS. 2 and 3 are exploded views of item dispensing system 10 from FIG. 1. Novelty portions 60 may be configured to include a gearing coupling portion 62 that extends through novelty apertures 52 in faceplate 50. Faceplate 50 may be also configured with a dispensing aperture 54 that, when aligned with dispensing orifices 24 in top housing 20, will allow items such as candy to pass from the interior of container 12 through dispensing orifice 24 and dispensing aperture 54 to the exterior of the system. Faceplate 50 also typically includes a gearing coupling aperture 56 configured to allow rotational gearing 74 to couple to the faceplate to couple the two.

Gearing coupling portion 62 of rotating novelty portion 60 is configured to extend through novelty aperture 52 of faceplate 50 and coupled to novelty gearing 70. Novelty gearing 70 is configured to rotationally couple to top housing 20 such that when faceplate 50 is rotated with respect to container 12 or top housing 20, novelty portions 60 may also rotate.

Top housing 20 typically includes integrated gearing 22 that is configured to couple to rotational gearing 74 and novelty gearing 70, such that when faceplate 50 is rotated with respect to container 12 or top housing 20, novelty portions 60 will rotate. With rotational gearing 74 rotationally coupled to one of novelty portions 60, this configuration will allow novelty portions 60 to rotate in opposite directions, as desired.

Top housing 20 also typically includes one or more dispensing apertures 24 that when aligned with dispensing aperture 54 of faceplate 50 will allow items such as candy to pass from the interior of container 12 to the exterior of the system.

Therefore, when a user, such as a child, desires to dispense candy from the system, the user rotates the faceplate to align the apertures to allow candy to pass from the interior to the exterior of the system. When the user rotates the faceplate to align the apertures, the novelty portions also rotate, enhancing the play value and adding enjoyment for everyone.

Bottom housing 40 typically includes a top housing coupling structure 42 that is configured to couple to top housing 20 at a bottom housing coupling structure. It will be appreciated, however, that although an interference fit configuration is shown, other coupling structures may be utilized, as desired. It will be appreciated that although top housing 20 is shown with sides, bottom housing 40 may also include a vertical cylindrical portion configuration, as desired.

Bottom housing 40 also typically includes a hinged portion 44 that will selectively couple to top housing 20 such that it may be opened and more items, such as candy, may be easily placed within container 12. Although hinged portion 44 and top housing 20 are configured to couple via a friction or interference fit, other selectively coupling structures may be utilized, as desired.

With this configuration a user, such as a child, may easily open the bottom and easily insert more candy, then dispense the candy in a fun and entertaining way by rotating the faceplate and thereby causing the novelty portions to rotate also.

Faceplate 50 typically rotationally couples to top housing 20 via an overlapped fit, however, other rotationally coupling configurations may be utilized, as desired. All of the parts of system 10 are typically made from a plastic material, however other materials, such as rubber and other polymers, among others, may be utilized, as desired.

FIG. 3 shows another exploded view of the exemplary embodiment in FIG. 1, showing novelty portions 60, which typically have a gearing coupling portion 62 and a visual portion 61. Gearing coupling portion 62 is typically configured to extend through an aperture of gearing to expand on the other side to couple them together. However, other coupling structures and configurations may be utilized, as desired. Similarly, rotational gearing 74 couples to faceplate 50 in a similar way, but other rotationally coupling configurations may be utilized, as desired. Also shown is the underside of faceplate 50, showing one exemplary configuration for rotational gearing 74 and gearing 70. Gearing coupling portion 62 of novelty portion 60 is configured to couple to novelty gearing 70. Novelty gearing 70 is configured to rotationally couple to the top housing such that when faceplate 50 is rotated with respect to container 12 or top housing 20, novelty portions 60 rotate also.

Gearing coupling portion 62 is typically formed along with visual portion 61 in one piece, however, they may be configured to be coupled together in many ways, as desired.

Although visual portion 61 is shown as eyes, or the like, it will be appreciated that many other types of novelty portions may be utilized to add to the play value and entertainment of the system, as desired. Faceplate 50 is typically in the form of a face of a caricature, but it will be appreciated that many other configurations may be utilized to add entertainment value to the system, as desired. Integrated gearing 22 may be configured such that on the exterior of the container 12, such that the operation of the gearing will not be impeded or interfered with by the items to be dispensed by the system.

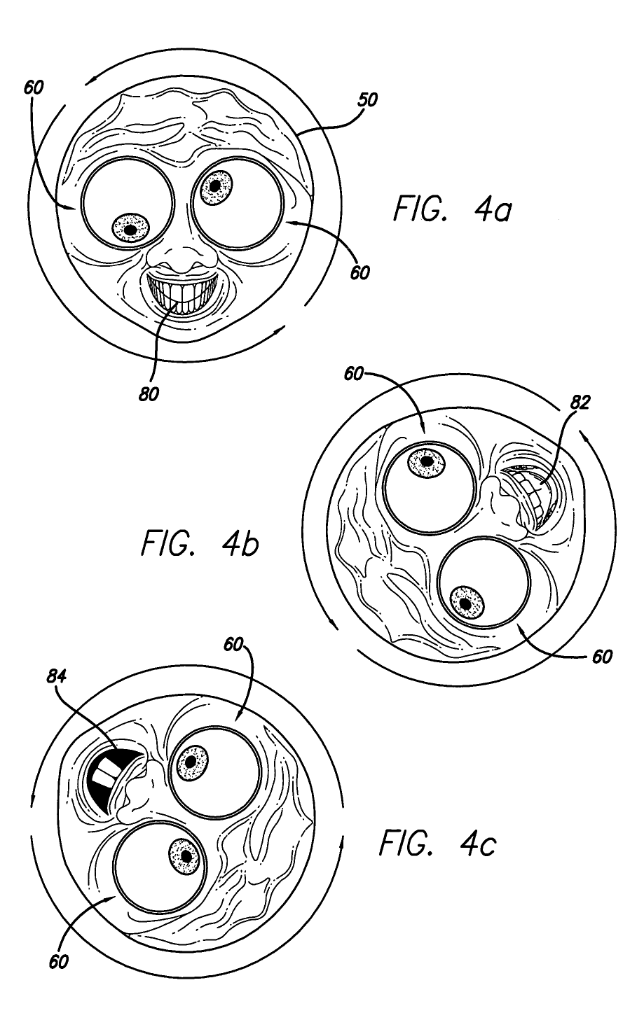

FIGS. 4a-c show the system in various rotational positions. Because faceplate 50 includes a dispensing aperture that may resemble the mouth of the caricature, top housing 20 may also include graphics 80, 82, and 84 between the dispensing orifices that may be visible when the dispensing aperture is aligned with them. This may make it appear as if the caricature's mouth is closed, open, having a full set of teeth, missing teeth, or many other configurations, as desired, to enhance play value and enjoyment of the system.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the drawings and description are illustrative and not meant to be a limitation thereof.

1. A dispensing system, comprising:
a top housing and a bottom housing configured to couple together to form an enclosure there between;
a faceplate configured to rotationally couple to said top housing; and
one or more novelty portions configured to move when said faceplate rotates with respect to said top housing.

2. The dispensing system of claim 1, further comprising gearing configured to rotationally couple said one or more novelty portions to said top housing.

3. The dispensing system of claim 2, wherein said gearing comprises one or more novelty gearing portions configured to couple to said one or more novelty portions, and to rotationally couple to said top housing portion.

4. The dispensing system of claim 3, wherein said gearing further comprises rotational gearing configured to rotationally couple to said top housing and to rotationally couple to said one or more novelty gearing portions.

5. The dispensing system of claim 1, wherein said top housing comprises:
integrated gearing configured to rotationally couple to said one or more novelty portions;
dispensing apertures configured to allow items to pass therethrough;
a faceplate coupling structure configured to rotationally couple to said faceplate; and
a bottom housing coupling structure configured to couple to said bottom housing.

6. The dispensing system of claim 5, wherein said top housing further comprises graphics between said dispensing apertures.

7. The dispensing system of claim 1, wherein said bottom housing comprises:
a top housing coupling structure configured to couple to said top housing; and
a hinged portion configured to hingedly couple to said top housing portion.

8. The dispensing system of claim 1, wherein said faceplate comprises:
one or more novelty apertures configured to allow said corresponding said one or more novelty portions to extend therethrough; and
dispensing apertures configured to allow items to pass therethrough.

9. The dispensing system of claim 1, wherein said one or more novelty portions comprise:
a visual portion; and
a gearing coupling portion coupled to said visual portion, and configured to couple to said gearing.

10. A confectionary dispensing system, comprising:
a container configured with one or more dispensing orifices, and configured to house items;
a faceplate configured with one or more dispensing apertures, rotationally coupled to said container, such that items may be dispensed from said container; and
one or more novelty portions coupled to said container, configured to move when said faceplate rotates with respect to said container.

11. The confectionary dispensing system of claim 10, further comprising gearing configured to rotationally couple said one or more novelty portions to said container.

12. The confectionary dispensing system of claim 11, wherein said container comprises:
a top housing including integrated gearing: and a bottom housing coupled to said top housing;
wherein said integrated gearing couples to said gearing such that said one or more novelty portions rotate when said faceplate rotates with respect to said container.

13. A dispensing system, comprising:
a top housing, including a faceplate;
a bottom housing configured to rotationally couple to said top housing to form an enclosure therebetween; and
one or more novelty portions configured to move when said top housing moves with respect to said bottom housing.

14. A container system, comprising:
a top housing including integrated gearing;
a bottom housing including a dispensing orifice, configured to couple to said top housing to form an enclosure therebetween;
a faceplate including a dispensing aperture, configured to rotationally couple to said top housing;
one or more novelty portions; and
gearing configured to rotationally couple said one or more novelty portions to said integrated gearing.

15. The container system of claim 14, wherein said bottom portion comprises a hinged portion that is configured to hingedly couple to said top housing.
